(19) United States
(12) Patent Application Publication
(10) Pub. No.: US 2007/0174894 A1
(43) Pub. Date: Jul. 26, 2007

(54) Transmitter, receiver, and broadcasting system

(76) Inventor: Shigeki Matsunaga, Osaka (JP)

Correspondence Address: MCDERMOTT WILL & EMERY LLP, 600 13TH STREET, N.W., WASHINGTON, DC, 20005-3096, US

(21) Appl. No.: 10/295,035

(22) Filed: Nov. 15, 2002

(30) Foreign Application Priority Data
Nov. 16, 2001 (JP) 2001-351374

(51) Int. Cl. H04N 7/16; H04N 7/00; H04N 11/00

(52) U.S. Cl. 725/135; 725/136; 348/461

(57) ABSTRACT

A system for providing a broadcasting service considering the environment on a receiver end. A transmitter transmits a command for operating a receiver and its peripheral devices, and connection requirement data being a requirement for the command execution. In the receiver, a reception section receives, together with the command, requirement data being a requirement for the command execution, and a determination section determines whether the requirement is satisfied. As an example, after receiving a command for printing out an English conversation textbook, the receiver can determine whether any printer is connected thereto. If a printer connection is verified, the printing command is accordingly executed.

### BACKGROUND OF THE INVENTION

1. Field of the Invention

The present invention relates to transmitters, receivers, and broadcasting systems.

2. Description of the Related Art

Through BS digital broadcasting and CS digital broadcasting, other than video and audio data, data transmission is possible for data broadcasting. Through data broadcasting, for example, viewers who are viewing live pro baseball games can see win-loss records or what other games are doing. As such, the viewers can enjoy a value-added broadcasting service, which has been, so far, considered impossible.

Here, some data for data broadcasting may preferably be printed out on paper. For example, as to textbooks for use in English conversation programs, or recipes in cooking programs, users may find it useful if those are available on paper, rather than those displayed on monitors.

For transmission of such paper-printing preferable data, proposed in Japanese Patent Laid-Open Publication No. 2001-223997 is to transmit a corresponding printing command from a broadcasting station. In this manner, any printer connected to receivers, e.g., set top boxes, becomes able to automatically print out such English conversation textbooks, recipes, and the like.

With the above conventional technology, however, the receiver end often fails to properly execute the command thus received from the broadcasting station. For example, when the receiver end has no printer even if the broadcasting station transmits thereto such a command for printing an English conversation textbook, the printing command cannot surely be executed properly.

Other than whether the receiver end is provided with a printer, the environment of the receiver end varies, for example, whether a hard disk is provided for recording. Despite such a varying environment on the receiver end, the conventional technology problematically offers only one type of broadcasting service. For users who cannot enjoy some specific services, there is no merit in receiving such service offers, and the users may feel annoyed thereby. That is, in the above example, for users who have no printer, a command execution for printing English conversation textbooks or recipes is uncalled for.

### SUMMARY OF THE INVENTION

The present invention has proposed in consideration of the above conventional problems, and an object thereof is to provide a broadcasting service considering in what environment the receiver end is.

The present invention is adopting the following means to achieve the above object.

In detail, transmitted from a transmitter is a command and connection requirement data. Here, the command is for operating a receiver and at least one of its peripheral devices. The connection requirement data is provided for the command execution, and is determined based on a combination of the peripheral devices connected to the receiver.

Based on the received command, the receiver is capable of operating itself and at least one of the peripheral devices.

In the receiver, a reception section receives the command, and the corresponding connection requirement data for the command execution. A determination section then analyzes the connection requirement data to see whether or not it is satisfied. If the connection requirement is determined as satisfied, a request is made for a peripheral device to execute the command corresponding to the requirement data. If not determined as satisfied, no command execution is requested, and an error notification is made to the user, or a recovery process is executed.

In this manner, a determination whether the receiver is connected with a printer can be made on the end having received from a transmitter a command for printing an English conversation textbook. This makes possible to execute the printing command only when printer connection is verified, successfully providing a broadcasting service matching to the environment on the receiver end.

Here, for the determination section to see whether the connection requirement is satisfied, the receiver is provided with a connection sensing section, or peripheral device specifying data. Here, the connection sensing section is for sensing if the receiver is connected with any peripheral devices, and if connected, the peripheral device specifying data is used to specify a peripheral device connected to the receiver. This data is internal data for holding information about the peripheral device(s) currently connected to the receiver, and the receiver updates the data contents every time the connection is established or cut off.

Even if the determination section determines as the connection requirement being satisfied, there may be a case where the subsequent process fails to be executed, i.e., the command transmitted from the transmitter cannot be properly executed on the receiver end. Assuming that, even if a printer is connected to the receiver having received a command for printing an English conversation textbook, the printing command cannot be properly executed if the printer is in an abnormal condition. To solve such a problem, the following structure may be adopted solely, or in combination with the above structure.

That is, the transmitter transmits, together with a command for operating the receiver and at least one of its peripheral devices, continuation requirement data for the command execution. Here, the continuation requirement data is determined depending on how a peripheral device connected to the receiver is operating.

If this is the case, the reception section in the receiver receives, together with the command, the continuation requirement data for the command execution. The determination section then analyzes the continuation requirement data to see whether or not it is satisfied.

The determination section operates, as a specific example, to determine whether the printer connected to the receiver having received the command for printing an English conversation textbook is in a normal condition. Such a combination of the determination section and the continuation requirement data is used to see whether the printer is normal in condition, and only when YES, the printing command is executed. As such, provided thereby is the broadcasting service matching to the environment of the receiver end.

In order for the determination section to see the operating condition of the printer, the receiver end is provided with a condition monitoring section for monitoring how a peripheral device connected to the receiver is operating.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is, schematically, a function block diagram of a receiver to which the present invention is applied;

FIG. 2 is a conceptual diagram of a radio wave to be transmitted from a broadcasting station, to which the present invention is applied;

FIGS. 3A and 3B are both conceptual diagrams of the radio wave to be transmitted from the broadcasting station, to which the present invention is applied;

FIG. 4 is a diagram showing the state in which a printing button is displayed on a monitor connected to a receiver;

FIG. 5 is a flowchart showing the operation of the receiver to which the present invention is applied;

FIG. 6 is a flowchart of the cooperative control applied in a first embodiment;

FIG. 7 is a flowchart of the cooperative control applied in a second embodiment;

FIG. 8 is a flowchart of the cooperative control applied in a third embodiment;

FIG. 9 is a flowchart of the cooperative control applied in a fourth embodiment;

FIG. 10 is a flowchart of the cooperative control applied in a fifth embodiment;

FIG. 11 shows a conceptual diagram of cooperative control data in the first embodiment; and

FIG. 12 shows a conceptual diagram of cooperative control data in the second embodiment.

### DESCRIPTION OF THE PREFERRED EMBODIMENTS

In the below, embodiments of the present invention are described in detail by referring to the accompanying drawings.

### First Embodiment

In the present embodiment, described is an exemplary case where, through a broadcasting service, a user on the receiver end can print out a textbook for use during an English conversation program.

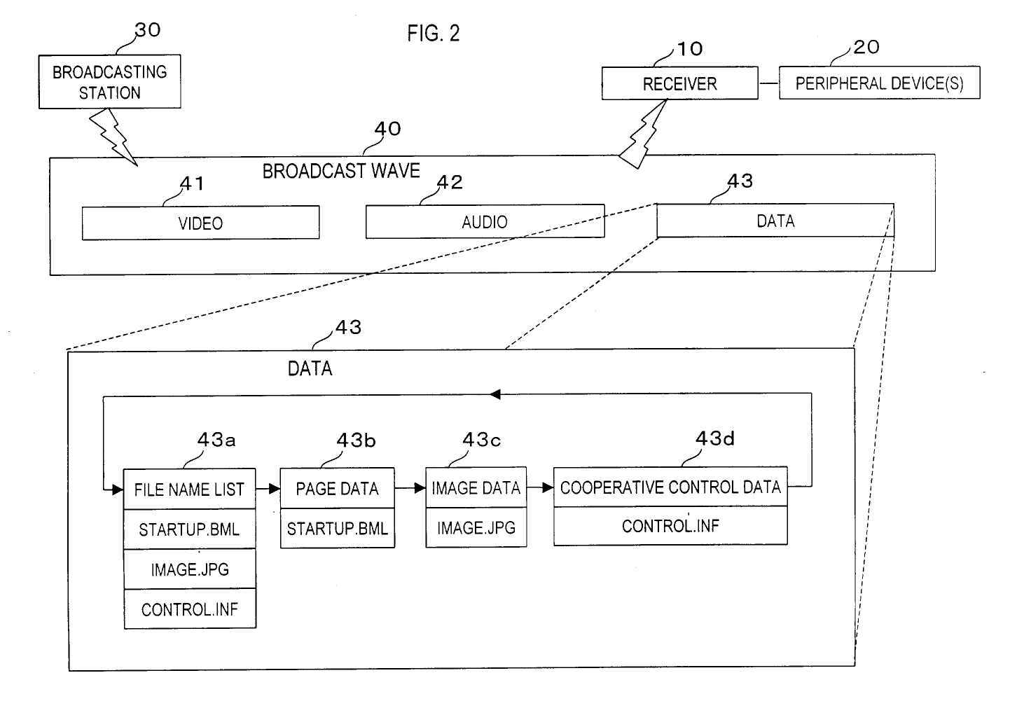

Referring to FIG. 2, a broadcasting station (transmitter) 30 transmits a broadcast wave 40 for multiplexed television and data broadcasting. For the purpose of exemplifying a broadcasting service through which a textbook is printed out for use during an English conversation program, assuming here that the English conversation program is provided on television broadcasting, and various data relevant to the program is provided on data broadcasting.

Here, through data broadcasting, cooperative control data 43d there for is characteristically transmitted. The cooperative control data 43d, which is described in detail below, is used to make a receiver 10 and at least one of its peripheral devices 20 operate in cooperation with each other. In the below, an expression of “cooperative control” means a cooperative control section A, which will be described later, making the receiver 10 and peripheral devices 20 operate in cooperation with one another. And an expression of “cooperative process” means a process to be carried out, responding to the cooperative control, by the receiver 10 and peripheral devices 20.

The cooperative control data 43d includes various commands for operating the receiver 10 and the peripheral device 20, and requirement data for the command execution. The requirement data mainly includes the following connection requirement data and continuation requirement data.

First, the connection requirement data is determined depending on a combination of peripheral devices 20 connected to the receiver 10. To be specific, in the cooperative control data 43d, a description part to make the receiver 10 check whether any connection is established with a printer (document image processor) or a hard disk (video recorder) corresponds to the “connection requirement data”.

The continuation requirement data, on the other hand, is determined depending on how a peripheral device 20 connected to the receiver 10 is operating. Specifically, in the cooperative control data 43d, a description part to make the receiver 10 determine how the connected printer or hard disk are operating corresponds to the “continuation requirement data”.

In the present embodiment, a carousel system is adopted to data broadcasting. This carousel system is a data transmission system under which the same data is repeatedly transmitted at regular intervals. That is, as shown in FIG. 2, the broadcasting station 30 repeatedly, at regular intervals, transmits page data 43b described in a BML (Broadcast Markup language), image data 43c linked in the page data 43b, cooperative control data 43d for data broadcasting, and a file name list 43a listing all of the data 43b, 43c, and 43d. Surely, transmitted is also the data of the English conversation textbook under the carousel system.

Adopting such a carousel system eliminates the need for the receiver 10 to equip cache memory, and enables data acquisition after a certain length of time. Accordingly, the receiver 10 can be advantageously structured at lower cost.

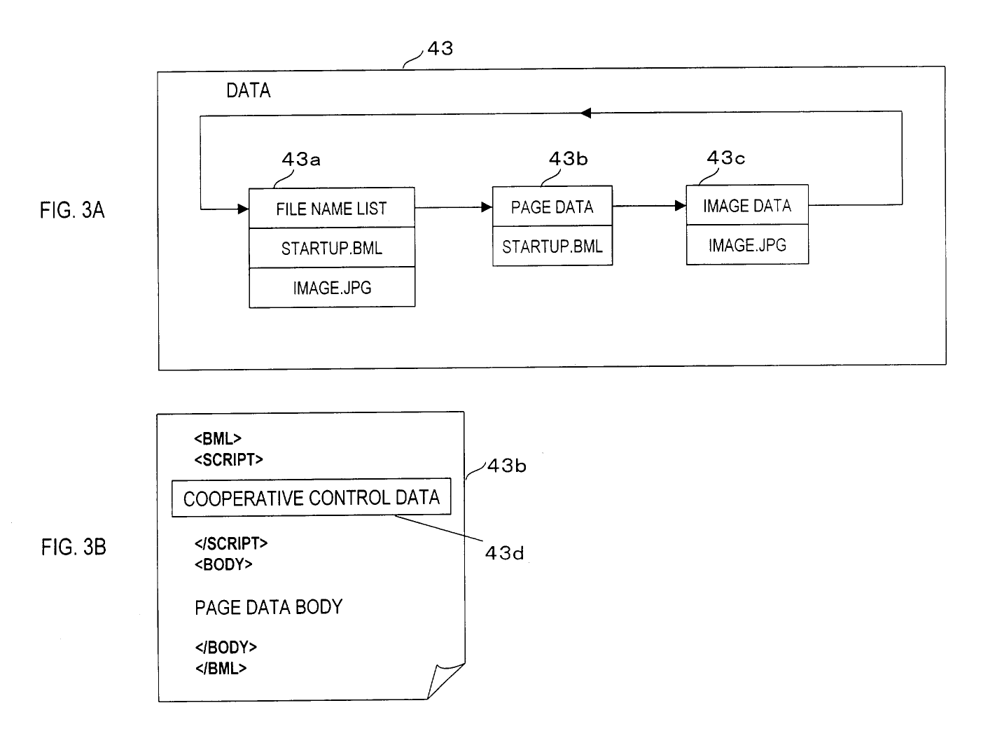

Here, the page data 43b and the cooperative control data 43d are both text data. Accordingly, as shown in FIGS. 3A and 3B, the page data 43b may include the cooperative control data 43d. For a content author, including the cooperative control data 43d in the page data 43b is preferable to separating the page data 43b and the cooperative data 43d into two different files, as shown in FIG. 2.

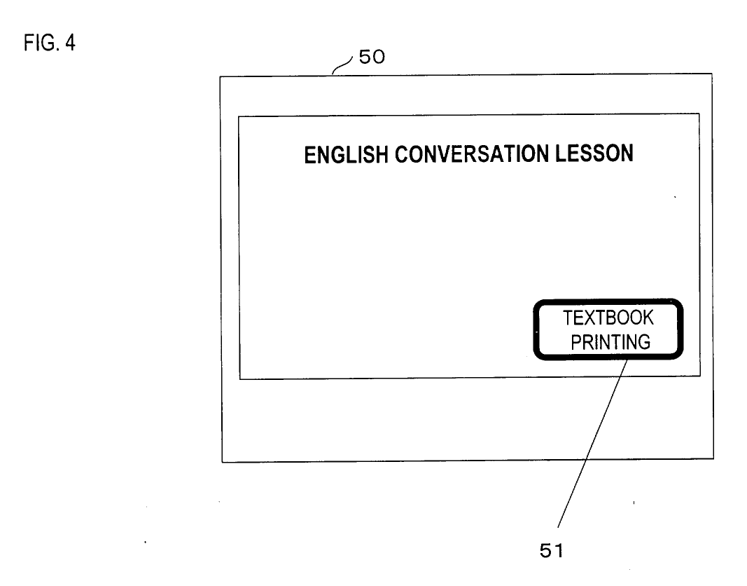

This is because a trigger to start the cooperative control is described in the page data 43b. In detail, referring to FIG. 4, in order to start the cooperative control responding to a printing button 51 depressed by a user of the receiver 10, there needs to describe both a trigger indicating the printing button 51 as having been depressed and the details of the cooperative control. It is easier to describe those in a single file (in this example, the page data 43b) rather than in two different files.

Exemplified in this example is a case of starting the cooperative control in response to the printing button 51 depressed by the user of the receiver 10. However, the trigger to start the cooperative control is not restrictive thereto. As an example, the cooperative control may be automatically started at a specific time.

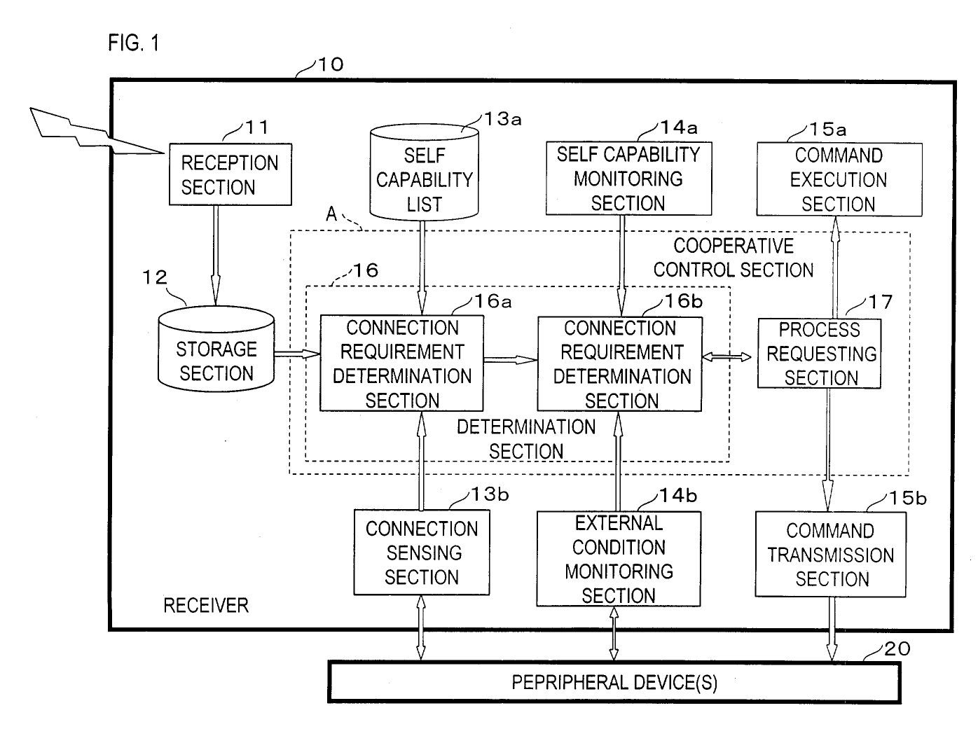

Described next is the structure and operation of the receiver 10 to which the present invention is applied. In the below, presumably, a set top box in such a structure as shown in FIG. 1 is used as the receiver 10. Surely, any device having the similar capabilities as the set top box is applicable.

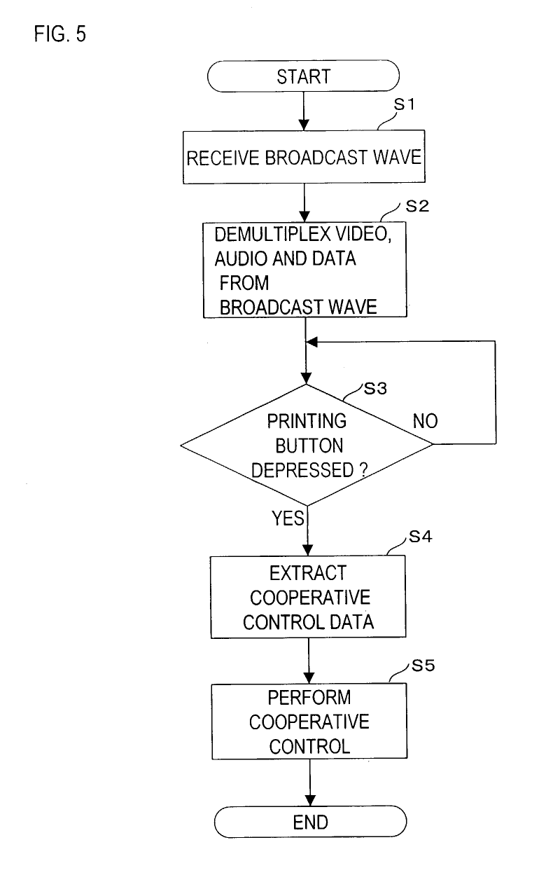

First, a reception section 11 of the receiver 10 receives the broadcast wave 40 from the broadcasting station 30, so that data 41 and 42 are acquired for television broadcasting, and data 43 for data broadcasting. The data 43 for data broadcasting is then stored in a storage section 12, e.g., a hard disk (FIG. 5, step S1 to step S2).

Herein, for example, the video data 41 and the audio data 42 structuring the data for television broadcasting are encoded in an MPEG format. Accordingly, the video data 41 is first subjected to a recovery process, for example, and then the result is output to a monitor. The audio data 42 is also subjected to a recovery process, for example, before output to a speaker. Such a processing has no direct relevance to the present embodiment, and thus no further description is given here.

After detecting storage of the data 43 for data broadcasting in the storage section 12, the cooperative control section A reads thus stored data 43 for detail interpretation. Although the details of the data 43 thus affect the following operation, a goal in this example is to print out an English conversation textbook for use. Thus, as shown in FIG. 4, a monitor 50 connected to the receiver 10 is assumed to display the button 51 to print out the English conversation textbook.

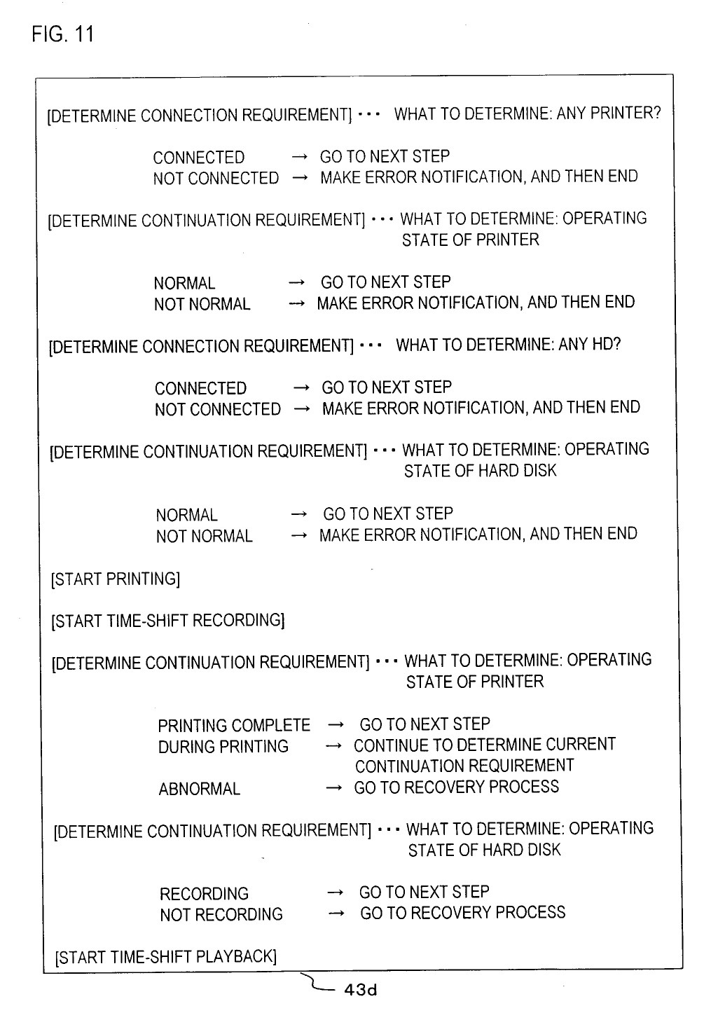

When the printing button 51 is depressed by the user, the cooperative control section A extracts the cooperative control data 43d from the read data 43 for data broadcasting (FIG. 5, step S3 to step S4). Then, in accordance with the description of thus extracted cooperative control data 43d (see FIG. 11 for its conceptual diagram), the following cooperative control is applied (FIG. 5, step S5).

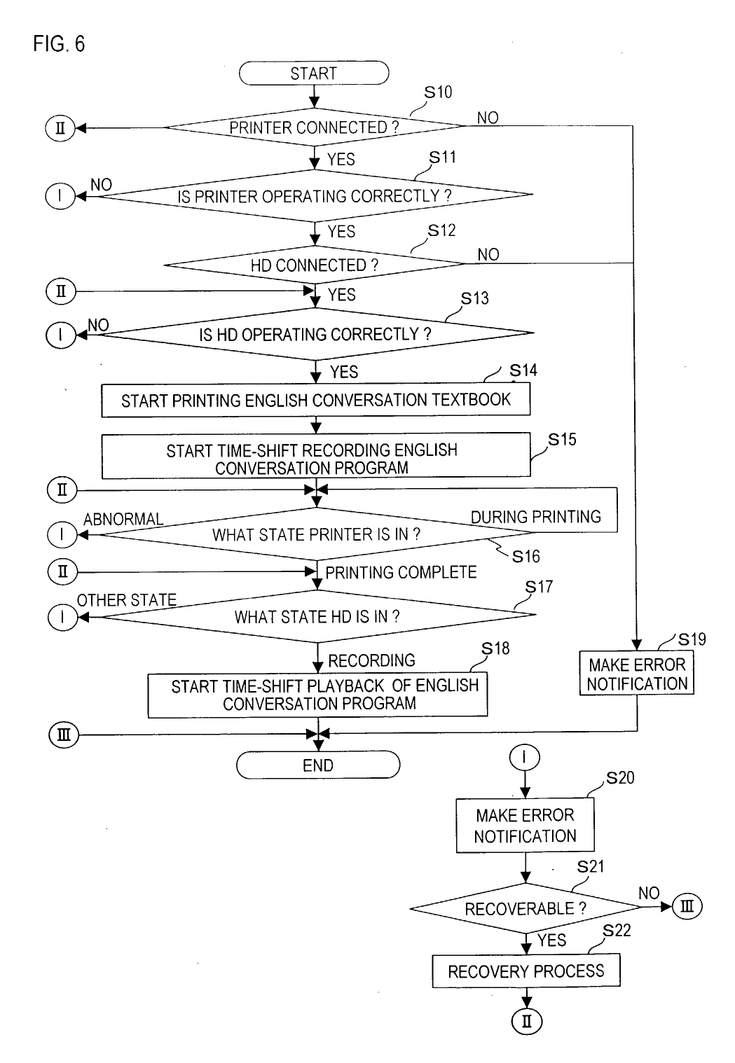

First of all, in the cooperative control section A, a connection requirement determination section 16a inquires a connection sensing section 13b whether the receiver 10 is connected with a printer. If the connection sensing section 13b senses a printer connection, the cooperative control is continuously applied (FIG. 6, step S10: YES). On the other hand, if no printer connection is sensed by the connection sensing section 13b, an error notification is provided to indicate as such (FIG. 6, step S10:NO goes to step S19). In response to such an error notification, the monitor 50 displays an error message telling “no printer connected”, for example.

Here, although exemplified above is a case where the connection requirement determination section 16a inquires the connection sensing section 13b whether the receiver 10 is connected with a printer, the present invention is not restrictive thereto. That is, to achieve the similar effects as above, peripheral device specifying data (not shown) may be retained in advance for reference by the connection requirement determination section 16a. Herein, the peripheral device specifying data is provided for specifying a peripheral device 20 connected to the receiver 10. In the below, this data is referred to simply as a “list” because it is assumed to be written in a list. In this example, this internally-stored peripheral device specifying data is updated every time the connection sensing section 13b senses any connection establishment or connection cut-off between the receiver 10 and its peripheral devices.

Compared with the above structure as the connection requirement determination section 16a making an inquiry to the connection sensing section 13b, the structure as using the list can advantageously shorten the processing time. Specifically, in the above structure as the connection requirement determination section 16a making an inquiry to the connection sensing section 13b, a process for connection sensing has to wait for the user's instruction to start. Such a connection sensing process is executed beforehand in the case of using the list, and thus a process result can be returned immediately after the user's instruction comes.

Next, in the cooperative control section A, a continuation requirement determination section 16b inquires an external condition monitoring section 14b how the printer connected to the receiver 10 is operating. If the printer is operating correctly, the cooperative control is continuously applied (FIG. 6, step S11: YES), and if not operating correctly (e.g., out of paper, no ink), an error notification is made to indicate as such (FIG. 6, step S11: NO goes to step S20).

In response to such an error notification, the monitor 50 displays an error message as “out of paper”, “no ink”, or the like. If this error is not recoverable, applying the cooperative control is stopped (FIG. 6, step S21: NO goes to Finish). If recoverable, the cooperative control is continuously applied after the corresponding recovery process is through (FIG. 6, step S21: YES goes to step S22).

Note here that, the content author is allowed to designate, as a continuation requirement, a paper size, count, or the like, for content printing. Accordingly, if the printer is not equipped with a paper of the designated size, in step S11 of FIG. 6, the continuation requirement determination section 16b determines as “printer is not operating correctly”.

For example, if the printer is not equipped with an A4 sized paper for content printing, which is the designated continuation requirement, the continuation requirement determination section 16b determines in step S11 of FIG. 6 as “the printer is not operating correctly”. Similarly, if the printer is not equipped with 10 pieces of paper or more for content printing, which is the designated continuation requirement, the continuation requirement determination section 16b determines in step S11 of FIG. 6 as “the printer is not operating correctly”.

Next, the connection requirement determination section 16a refers to a self capability list 13a to check whether the receiver 10 is connected with a hard disk (whether the receiver 10 is incorporating a hard disk). If a hard disk connection is verified, the cooperative control is continuously applied (FIG. 6, step S12: YES), and if no hard disk is connected, an error notification is made to indicate as such (FIG. 6, step S12: NO goes to step S19). In response to such an error notification, the monitor 50 displays an error message telling “no hard disk connected”, for example.

Herein, exemplified above is a case where the connection requirement determination section 16a refers to the self capability list 13a to check whether the receiver 10 is connected with a hard disk, but the present invention is not restrictive thereto. For example, to achieve the similar effects as above, a self capability sensing section (not shown) may be provided to see which capabilities are available or not at the receiver itself. With respect to the self capability sensing section, the connection requirement determination section 16a may inquire about a hard disk connection to the receiver 10.

Next, the continuation requirement determination section 16b inquires the self capability monitoring section 14a about how the hard disk connected to the receiver 10 is operating. If the hard disk is operating correctly, the cooperative control is continuously applied (FIG. 6, step S13: YES). On the other hand, if the hard disk is not operating correctly (e.g., out of memory), an error notification is made to indicate as such (FIG. 6, step S13: NO goes to step S20).

In response to such an error notification, the monitor 50 displays an error message telling “out of memory”, for example. If this error is not recoverable, applying the cooperative control is stopped (FIG. 6, step S21: NO goes to Finish), and if the error is recoverable, the cooperative control is continuously applied after the corresponding recovery process is through (FIG. 6, step S21: YES goes to step S22).

Next, in the cooperative control section A, a process requesting section 17 requests a command transmission section 15b to transmit a printing command to the printer. Upon reception of such a request, the command transmission section 15b transmits, to the printer, the printing command and the data of the English conversation textbook to be printed. In this manner, printing the English conversation textbook is started (FIG. 6, step S14).

The process requesting section 17 is so structured as to request a command execution section 15a to start time-shift recording, simultaneously with requesting the command transmission section 15b to transmit the printing command in the above manner. Thus requested command execution section 15a responsively starts time-shift recording of the English conversation program (FIG. 6, step S15).

Thereafter, the continuation requirement determination section 16b keep inquiring the external condition monitoring section 14b until the operating state of the printer changes into a printing complete state. Before the state change, if any abnormal condition such as paper jamming occurs, an error notification is made to indicate as such (FIG. 6, step S16: abnormal condition to step S20).

In response to such an error notification, the monitor 50 displays an error message telling “paper jamming occurred”, for example. If this error is not recoverable, applying the cooperative control is stopped (FIG. 6, step S21: NO goes to finish), and if recoverable, the cooperative control is started again after the corresponding recovery process is through (FIG. 6, step S21: YES goes to step S22).

After the state of the printer changes into a printing complete state (FIG. 6, step S16: printing complete), the continuation requirement determination section 16b inquires the self capability state monitoring section 14a how the hard disk connected to the receiver 10 is operating. Then, if the hard disk is currently in a recording state, a request is made to the command execution section 15a to start time-shift recording, and accordingly time-shift recording of the English conversation program is started (FIG. 6, step S17 to step S18). In such a manner, the monitor 50 starts displaying the English conversation program when the printing button 51 is depressed.

On the other hand, if the hard disk is in a state other than recording, the continuation requirement determination section 16b makes an error notification indicating as such (FIG. 6, step S17: other states to step S20). In response to such an error notification, the monitor 50 displays an error message telling “failed in time-shift recording of the program”, for example. If this error is not recoverable, applying the cooperative control is stopped (FIG. 6, step S21: NO goes to Finish), and if the error is recoverable, the cooperative control is continuously applied after the corresponding recovery process is through (FIG. 6, step S21: YES goes to step S22).

As such, in the present embodiment, as to the receiver 10 connected with neither printer nor hard disk, and if either connected, depending on whether it is operating correctly, the monitor 50 displays each different error message.

With such a setting, for the user of the receiver 10 having no printer or hard disk connected, a quick notification becomes possible to tell him/her that the current broadcasting service is not available. Similarly, to the user of the receiver 10 who is forgetting about establishing a printer connection, advantageously encouraging him/her to establish the connection. What is better, paper jamming will never be left unrecovered.

According to the present embodiment, the receiver 10 and its peripheral device 20 operate in cooperation with one another, successfully providing a value-added broadcasting service. That is, with the cooperative control exemplified above, time-shift recording is started right after the button 51 for printing out the English conversation textbook is depressed, and right after the printing is completed, time-shift playback is started. In such a manner, the program never proceeds with the user having no English conversation textbook.

Note that, in FIG. 6, after step S10 (S12) of determining the connection requirement is through, step S11 (S13) of determining the continuation requirement is executed. However, this order is not restrictive in the present invention. In detail, steps S10 (S12) and S11 (S13) may be executed at the same time. Herein, if the continuation requirement is found out as not being satisfied, e.g., the printer is not operating correctly, a setting is made for the procedure to feed back to the main process, that is, the step of determining connection requirement, e.g., step to see whether any printer is connected.

### Second Embodiment

In the following second embodiment, described are only differences from the above first embodiment.

First, exemplified in the above first embodiment is a case where the broadcasting service is offered only to the receiver 10 to which both a printer and a hard disk are connected. In other words, to the receiver 10 connected with neither a printer nor a hard disk, the monitor 50 displays an error message telling as such.

However, if the content author wants, it is possible to offer a broadcasting service each matching to the connection state of the receiver 10, e.g., the receiver 10 connected only with a printer, the receiver 10 connected only with a hard disk, the receiver 10 connected with neither a printer nor a hard disk. If this is the case, instead of going through the step of displaying on the monitor 50 an error message of “no printer connected”, the cooperative control data 43d may be so structured as to realize a broadcasting service offerable with no printer connected.

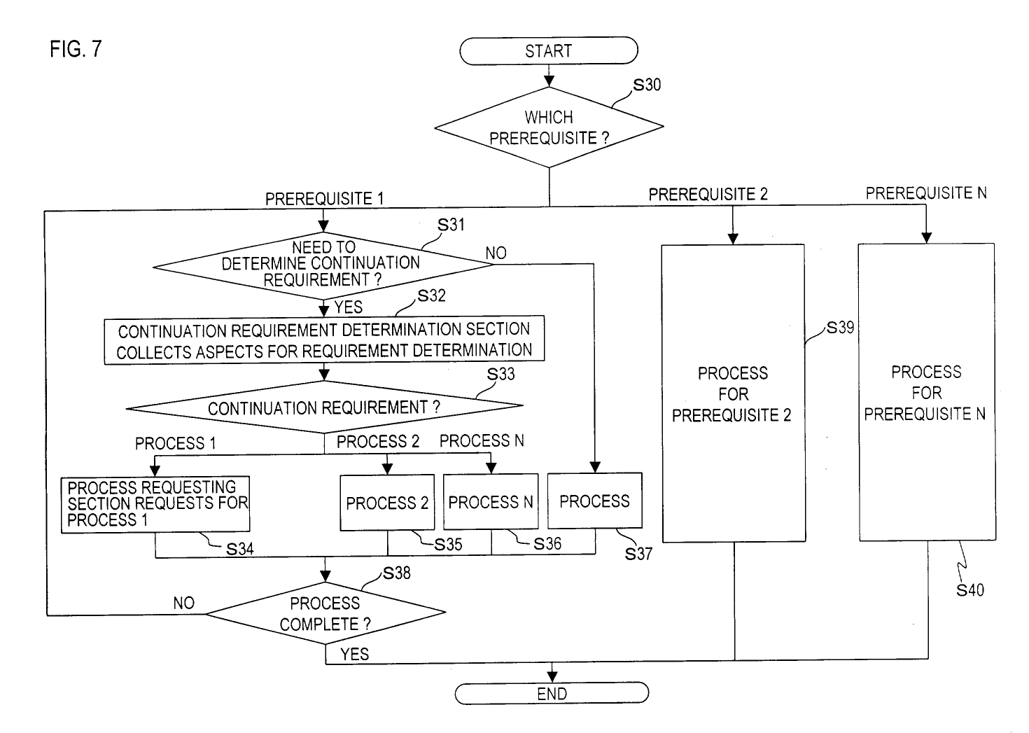

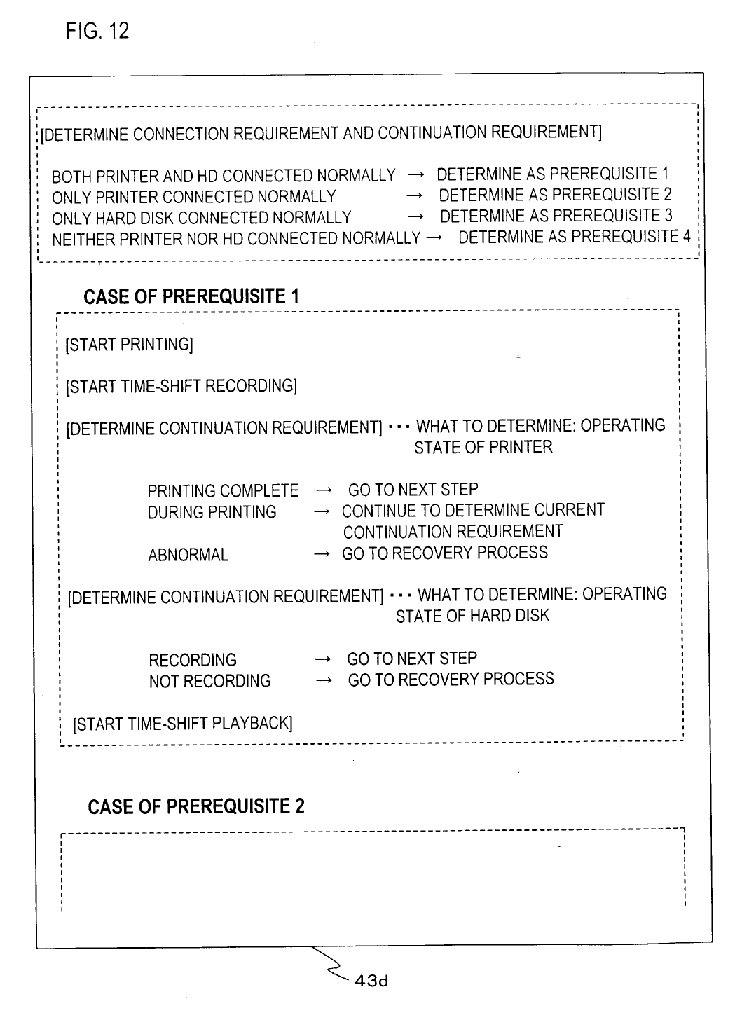

In order to offer a broadcasting service each matching to the above four prerequisites, as shown in FIG. 7, the cooperative control data 43d (see FIG. 12 for its conceptual diagram) may be so structured as to specify, before the cooperative control is started, which of the prerequisites 1 to n (in this example, the prerequisites 1 to 4) is applicable. Herein, the four prerequisites are in order: both a printer and a hard disk are normally connected; only a printer is normally connected; only a hard disk is normally connected; and neither printer nor hard disk is normally connected.

In more detail, after starting the cooperative control with a procedure of steps S1 to S5 in FIG. 5, first checked is whether a printer is normally connected, and then whether a hard disk is connected normally. For each of the resultantly derived n prerequisites (four prerequisites in this example), the cooperative process is set to go through each different step (FIG. 7, step S30 to step S31, step S30 to step S39, . . . , step S30 to step S40).

Thereafter, determined is whether to determine the continuation requirement (FIG. 7, step S31). As an example, with the prerequisite 1, the cooperative control data 43d of FIG. 12 shows a description as “start printing”. Accordingly, to perform the cooperative control based on the cooperative control data 43d, determined in step S31 of FIG. 7 is there is no need to determine the continuation requirement, and thus the procedure goes to step S37. Surely, step S37 herein corresponds to the process described in the head record, i.e., the process of “start printing”.

Until the need arises to determine the continuation requirement, such a procedure is repeated (FIG. 7, step S38: NO goes to step S31: NO goes to step S37, and then to step S38: NO goes to . . . , and then to step S31: YES). If the need arises to determine the continuation requirement, the continuation requirement determination section 16b collects any aspects for requirement determination (FIG. 7, step S31: YES goes to step S32). The aspects for requirement determination here denote the operating condition of the printer or the hard disk.

In the cooperative control data 43d of FIG. 12, the cooperative control process is further branched depending on to which level the continuation requirement is satisfied (FIG. 7, step S33 to step S34, step S33 to step S35, . . . , step S33 to step S36). As a result, if the continuation requirement is entirely satisfied, the process requesting section 17 requests the command execution section 15a or the command transmission section 15b to execute the corresponding cooperative process 1.

As described in the above, in the present embodiment, it is possible to provide a broadcasting service each matching to the connection state of the receiver 10, e.g., the receiver 10 connected only with a printer, the receiver 10 connected only with a hard disk, the receiver 10 connected with neither printer nor hard disk.

In a case where the receiver 10 is connected with any other peripheral devices, similarly, the cooperative control data may include a plurality of requirement data each corresponding to a single peripheral device or their combinations, and commands to be executed when the corresponding requirement represented by each requirement data is satisfied.

### Third Embodiment

In the following third embodiment, described are only differences from the above first embodiment. In the first embodiment, exemplified is a broadcasting service through which an English conversation textbook is printed out for use. In the present embodiment, to demonstrate the present invention, exemplified is a broadcasting service of offering a soccer game, simultaneously transmitting moving images of impressive scenes in soccer game programs.

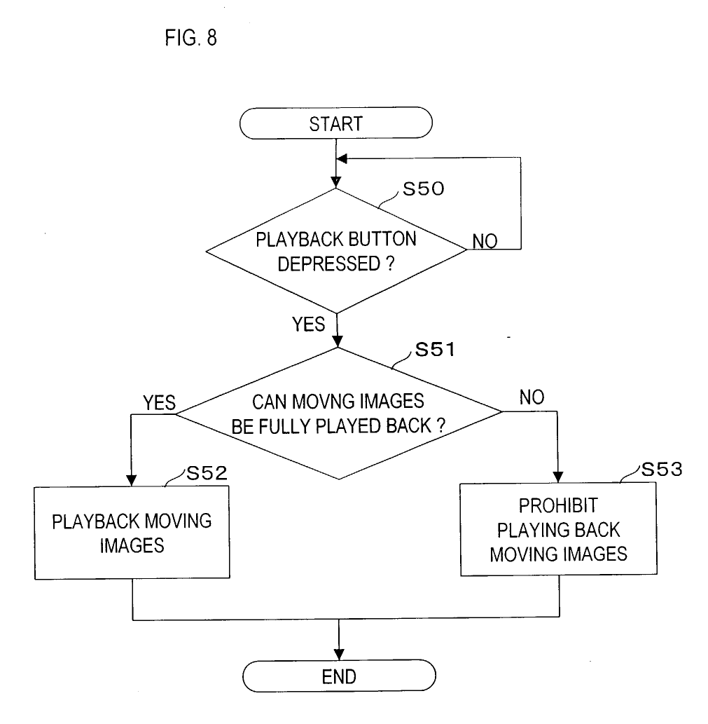

First, a button for playing back such moving images (impressive scenes in soccer game programs) is displayed on the monitor 50 of the receiver 10. When the user depresses the playback button (FIG. 8, step S50: YES), immediately afterward time-shift recording is started for the soccer broadcasting. Then, after the moving images are thoroughly played back, time-shift playback is started. Such an operation is almost the same as that in the first embodiment except two differences: the broadcasting program is not an English conversation program but a soccer game; and the user's button push does not print out an English conversation textbook but plays back moving images. Therefore, no further description is given here.

Through such a broadcasting service, a playback time available for moving images is limited to a time frame during when a soccer game is broadcast, and playing back the moving images will be charged. In such cases, it is preferable to adopt the following structure to the structure described in the above first embodiment.

At the time of transmitting chargeable moving images, the broadcasting station 30 is so set as to also transmit time data needed for playing back those. Assuming here that the time data represents 10 minutes. When the time available for playing back the moving images shows less than 10 minutes, playing back the moving images on the receiver 10 end is prohibited by, for example, not displaying the playback button thereon (FIG. 8, step S51: NO goes to step S53).

In such a manner, the moving images are allowed to be played back only when those are to be thoroughly played back (FIG. 8, step S51: YES goes to step S52). Thus, for the user, depressing a playback button always promises him/her for the full moving images with payment. With the above structure, however, there may cause the following problems.

First, the receiver 10 should be provided with time means, which is not shown. If so, with respect to thus provided time means, the determination section 16 additionally needs to make an inquiry about the time, for example. Here, the determination section 16 is either the connection requirement determination section 16a or the continuation requirement determination section 16b.

In the above example, the time data representing 10 minutes is transmitted from the broadcasting station 30. With such a structure, however, the receiver 10 has to be always the same in capability to achieve accurate control. If the broadcasting station 30 transmits the time data representing 10 minutes to the receiver 10 whose capability is higher than assumed, the moving images will be finished being played back within 10 minutes. And if the receiver 10 whose capability is lower than assumed plays back the moving images, 10 minutes is not enough for full playback.

To solve these problems, adopting the following means is preferable.

First, as to the moving images, the broadcast station 30 transmits computing data, i.e., the image size, and the bit rate to compute the time to be taken for playing back the moving images. Assuming that the image size is 100 MB, and the bit rate is 10MB, a computation of 100 MB 10 MB by the receiver 10 tells that playing back the moving images requires 10 seconds.

In the above example of playing back the moving images on the receiver 10 end, described is the operation of transmitting from the broadcast station 30 the image size and the bit rate of the moving images, both of which are used as data for computing the playback time for the moving images. Alternatively, in the case where the playback/output time is dependent on the capability of the receiver 10, using a MIPS value is a possibility. Here, the MIPS value is used to estimate the processing speed of the computer, and is a value indicating a typical instruction being executable millions of times per second.

As an example, to apply such a MIPS to the case of printing out an English conversation textbook in the first embodiment on the receiver 10 end, the broadcasting station 30 transmits the MIPS value as data to compute the time taken to converse the English conversation textbook to a printer description language. The receiver 10 then computes, based on the above computing data and its own capability, the time needed to generate the output data. For example, transmitted from the broadcasting station 30 is the computing data representing “30 seconds with 100 MIPS”. If the capability of the receiver 10 is 200 MIPS, computing 100 MIPS÷200 MIPS×30 seconds will do. In this manner, the receiver 10 can accurately compute the time needed to generate the printer description language, i.e., 15 seconds.

On the other hand, if transmitted from the broadcasting station 30 is the computing data representing “30 seconds with 100 MIPS”, and if the capability of the receiver 10 is 50 MIPS, computing 100 MIPS÷50 MIPS×30 seconds will do. As a result, the receiver 10 can accurately compute the time needed to generate the printer description language, i.e., 60 seconds.

If there needs to know the capability of the printer connected to the receiver 10 for the purpose of computing the time to fully print out the English conversation textbook on the receiver 10 end, the external condition monitoring section 14b may be so structured as to inquire the printer about its capability.

### Fourth Embodiment

In the above first embodiment, a printer and a hard disk are exemplified as the peripheral devices (internal devices included) 20 of the receiver 10. However, the peripheral devices 20 of the receiver 10 are not restrictive thereto. Some broadcasting service may require any devices other than the printer and the hard disk. If this is the case, the technical concept similar to the first embodiment will operate those in cooperation with one another.

In the following fourth embodiment, described are only differences from the above first embodiment by exemplifying a broadcasting service through which a user who desires content printing views, without fail, a predetermined CM.

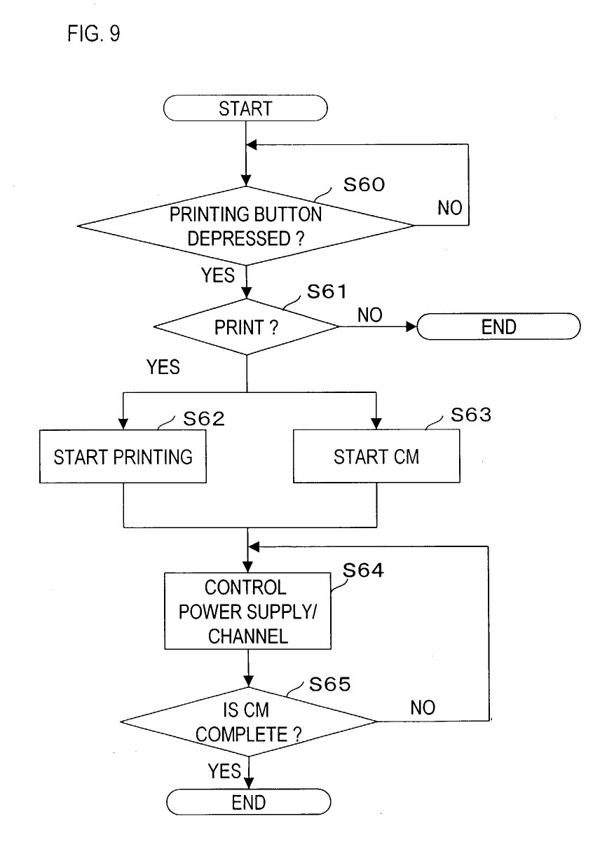

First, a button for printing out an English conversation textbook is displayed on the monitor 50 of the receiver 10. Responding to a user's push on the printing button, the monitor 50 displays a message telling that no such printing is available without viewing a CM (FIG. 9, step S60: YES goes to step S61).

In response thereto, if the user instructs to stop printing the English conversation textbook, this is the end of the cooperative control (FIG. 9, step S61: NO goes to Finish). If the user agrees to view the CM, on the other hand, the command transmission section 15b forwards to the printer the printing command and the data of the English conversation textbook for printing, and the command execution section 15a starts playing back the CM content (FIG. 9, step S61: YES goes to steps S62 and S63).

Once printing of the English conversation textbook is started, similarly to the first embodiment, it is preferable to start time-shift recording of the English conversation program. If so, time-shift recording may be started right after the button is depressed by the user for printing the English conversation textbook, or when the user agrees to view the CM.

As a result, during when the English conversation textbook is being printed, the monitor 50 displays, for example, a CM of the English conversation lesson. Here, the CM content is surely not restrictive to the English conversation lesson. The content author is at liberty to display which CM.

Here, preferably, the command execution section 15a playing back the CM and a power supply control section (not shown) under which the power supply of the receiver 10 is controlled are cooperatively controlled during when the CM is displayed on the monitor 50. This is to prevent the power supply of the receiver 10 from being turned OFF (FIG. 9, step S64 to step S65: NO goes to step S64, and then to . . . ). Similarly, it is preferable to cooperatively control the command execution section 15a playing back the CM and a channel switching section (not shown) under which channel switching is controlled. This is to stop channel switching during when the CM is displayed on the monitor 50 (FIG. 9, step S64 to step S65: NO goes to step S64, and then to . . . ).

In such a manner, the CM is always fully offered to the user because the power supply of the receiver 10 is never turned OFF or no channel switching occurs during the CM. According to the present embodiment, users whoever desire content printing never miss a predetermined CM.

### Fifth Embodiment

Mainly exemplified in the above first to fourth embodiments is a service realizable by the cooperative operation between the receiver 10 and a printer. Described in the following fifth embodiment is a service realizable by cooperatively controlling the receiver 10 and electric home appliances.

Described below are only differences from the above first embodiment as to a broadcasting service for providing a hint of what to buy to users who are viewing a food shopping program.

First, the broadcasting station 30 transmits a food shopping program, and provides data broadcasting relevant to the program. In the data for data broadcasting, included is the cooperative control data 43d for operating the receiver 10 and a refrigerator in cooperation with each other.

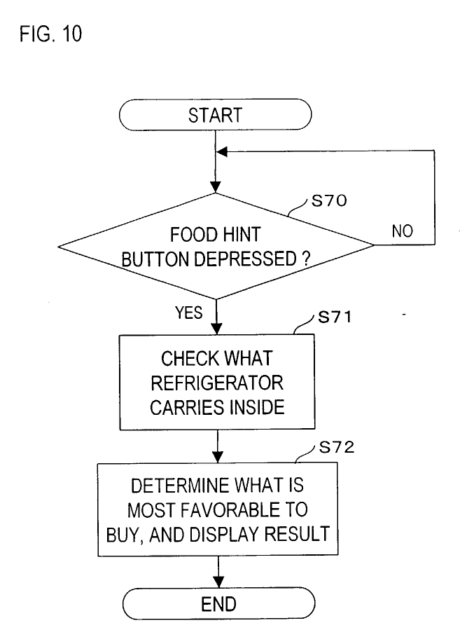

Thereby, when the user of the receiver 10 pushes a food hint button displayed on the monitor 50 (FIG. 10, step S70: YES), for example, after detecting the button push, the connection requirement determination section 16a inquires the connection sensing section 13b whether the receiver 10 is connected with a refrigerator in the similar manner to the first embodiment. If the connection sensing section 13b senses the refrigerator connection, the continuation requirement determination section 16b inquires the external condition monitoring section 14b about how the refrigerator is operating.

If the refrigerator is found out as being operating properly, the continuation requirement determination section 16b inquires the external condition monitoring section 14b about what the refrigerator carries therein (FIG. 10, step S71). Based on the answer provided from the external condition monitoring section 14b, i.e., data of the food in the refrigerator and data-broadcast menu data, a determination is made what to buy, and the result is displayed on the monitor 50 (FIG. 10, step S72).

For example, when the refrigerator carries therein a carrot and beef, the monitor 50 may display a message to buy potatoes to make curry. Alternatively, a menu list using both the carrot and beef or either may be displayed.

As such, in the present embodiment, the user viewing a food shopping program is provided with a most-favorable hint of what to buy. Similarly, the cooperative control data is so structured as to include a command to display the contents determined based on data relevant to the program and the data provided from the peripheral devices. If so, the data from the peripheral devices can be referred to for changing the data relevant to the program for the user.

To realize such a service, there needs a technology of checking what the refrigerator carries therein, and notifying the result to the receiver 10. Such a technology can be realized by placing an IC tag, which will be described below, on each of the food in the refrigerator.

In more detail, with an IC tag reader, the register contents of an IC tag can be read via radio communications. In principles, utilized thereto is electromagnetic induction between two coils, one of which is used as a transmission/reception antenna of the IC tag reader, and the other is used as a transmission/reception antenna of the IC tag. In such a case, provided to the coil of the IC tag reader are a carrier oscillator, and a demodulator for demodulating a response signal, on the carrier, coming from the IC tag.

Moreover, the coil of the IC tag is connected with a modulator, and the IC tag is provided with a register. With the modulator, the contents of the register are put on (modulated) a response wave guided by the transmitted wave from the antenna. The register holds signals to be modulated by the modulator. The signals retained in the register are exemplified by food IDs for food identification, or food attribute information, e.g., information about shelf life.

With such an IC tag attached to food, a reading section provided inside of the refrigerator reads the register contents for notification to the receiver 10.

Note here that, exemplified above is the structure in which the receiver 10 and the refrigerator operate in cooperation with each other. However, the receiver 10 can surely operate in cooperation with any other electric home appliances. In a case where the receiver 10 exemplarily operates in cooperation with a microwave oven, a parameter of the microwave oven may be set depending on the progress of a cooking program so that the user of the receiver 10 can easily cook a dish introduced therein. In a case with an air conditioner, the room temperature may be changed in the course of a program so as to make the program more truthful.

As such, a broadcasting service through which the receiver 10 operates in cooperation with electric home appliances is available in varying combinations of program details and capabilities of the electric home appliances. Thus, although not every service is exemplified herein, the basic concept of the present invention is applicable to any broadcasting service if the receiver 10 and the electric home appliances operate in cooperation with one another therethrough.

As is evident from the above, according to the present invention, it is possible to offer a broadcasting service considering in what environment the receiver is. For example, as to the receiver connected with neither printer nor hard disk, and if either connected, depending on whether it is operating correctly, the monitor displays each different error message. With such a setting, for the user of the receiver having no printer or hard disk connected, a quick notification becomes possible to tell him/her that the current broadcasting service is not available. Similarly, to the user of the receiver who is forgetting about establishing a printer connection, advantageously encouraging him/her to establish the connection. What is better, paper jamming will never be left unrecovered.

Furthermore, according to the present invention, the receiver and its peripheral device(s) operate in cooperation with one another, successfully providing a value-added broadcasting service. That is, with the cooperative control exemplified above, time-shift recording is started right after the button for printing out the English conversation textbook is depressed, and right after the printing is completed, time-shift playback is started. In such a manner, the program never proceeds with the user having no English conversation textbook.

While the invention has been described in detail, the foregoing description is in all aspects illustrative and not restrictive. It is understood that numerous other modifications and variations can be devised without departing from the scope of the invention.

The invention claimed is:

1. A transmitter for transmitting a command with which a receiver and at least one of peripheral devices operate in cooperation with each other, wherein
together with the command, connection requirement data being a requirement for executing the command is transmitted.

2. A transmitter for transmitting a command with which a receiver and at least one of peripheral devices operate in cooperation with each other, wherein
together with the command, continuation requirement data being a requirement for executing the command is transmitted.

3. A transmitter for transmitting a command with which a receiver and at least one of peripheral devices operate in cooperation with each other, wherein
together with the command, connection requirement data and continuation requirement data both being a requirement for executing the command are transmitted.

4. The transmitter according to claim 1 or 3, wherein the connection requirement data is determined by a combination of the peripheral devices connected to the receiver.

5. The transmitter according to claim 2 or 3, wherein the continuation requirement data is determined by how the peripheral device connected to the receiver is operating.

6. The transmitter according to any one of claims 1 to 3, wherein together with a content, computing data is transmitted to compute a time to playback or output the content.

7. The transmitter according to any one of claims 1 to 6, transmission adopts a carousel system.

8. The transmitter according to claim 7, wherein data to be transmitted under the carousel system is separated, before transmission, from page data for data broadcasting.

9. The transmitter according to claim 7, wherein data to be transmitted under the carousel system is included, before transmission, in the page data for data broadcasting.

10. A receiver capable of operating itself and at least one of peripheral devices in cooperation with each other based on a received command, the receiver comprising:
a reception section for receiving, together with the command, connection requirement data being a requirement for executing the command; and
a determination section for determining whether the connection requirement data is satisfied through analysis thereof.

11. A receiver capable of operating itself and at least one of peripheral devices in cooperation with each other based on a received command, the receiver comprising:
a reception section for receiving, together with the command, continuation requirement data being a requirement for executing the command; and
a determination section for determining whether the continuation requirement data is satisfied through analysis thereof.

12. A receiver capable of operating itself and at least one of peripheral devices in cooperation with each other based on a received command, the receiver comprising:
a reception section for receiving, together with the command, connection requirement data and continuation requirement data both being a requirement for executing the command; and
a determination section for determining whether the connection requirement data and the continuation requirement data are satisfied through analysis thereof.

13. A receiver, comprising a connection sensing section for sensing whether any peripheral device is connected to the receiver.

14. A receiver, comprising peripheral device specifying data for specifying a peripheral device connected to the receiver.

15. A receiver, comprising a condition monitoring section for monitoring how a peripheral device connected to the receiver is operating.

16. The receiver according to any one of claims 10 to 15, wherein the receiver is a set top box.

17. The receiver according to any one of claims 10 to 15, wherein the peripheral device is a document image processor.

18. The receiver according to any one of claims 10 to 15, wherein the peripheral devices are a document image processor and a video recorder.

19. The receiver according to claim 10 or 12, wherein the command is for content printing, and the connection requirement data indicates that the receiver is connected with a document image processor.

20. The receiver according to claim 11 or 12, wherein the command is for content printing, and the continuation requirement data indicates that a document image processor connected to the receiver is operating correctly.

21. The receiver according to claim 10 or 12, wherein the command is for time-shift recording a content, and the connection requirement data indicates that the receiver is connected with a video recorder.

22. The receiver according to claim 11 or 12, wherein the command is for time-shift recording a content, and the continuation requirement data indicates that a video recorder connected to the receiver is operating correctly.

23. The receiver according to claim 10 or 12, wherein the command is for time-shift playback of a content, and the connection requirement data indicates that the receiver is connected with a video recorder.

24. The receiver according to claim 11 or 12, wherein the command is for time-shift playback of a content, and the continuation requirement data indicates that a video recorder connected to the receiver is in a recording state.

25. A broadcasting system inwhich a transmitter transmits, at least, a content, and control data describing a process flow to be executed on a receiver end having received the content, and
in response, a receiver having received the content and the control data checks whether a printer and a hard disk for content recording are connected thereto, and if both are connected, starts time-shift recording after the content printing is started, and when the content printing is complete, starts time-shift playback.

26. A receiver for receiving a broadcast program, comprising:
a reception section for receiving cooperative control data including a command for operating a peripheral device relevant to the program, and requirement data representing a requirement for executing the command; and
a cooperative control section for determining, based on whether the peripheral device is connected, and if connected, depending on in what state the connected peripheral device is, whether the requirement represented by the requirement data is satisfied, and if satisfied, making a request for the peripheral device to execute the command corresponding to the requirement data.

27. The receiver according to claim 26, wherein the cooperative control data includes the requirement data representing a requirement that the receiver is connected with both a document image processor and a video recorder, and a plurality of commands to be executed when the requirement is satisfied, and
the plurality of commands include a command for making the document image processor print out a content relevant to the program, a command to be executed after the content printing is started for time-shift recording the program into the video recorder, and a command to be executed after the content printing is complete for time-shift playback of the recorded program.

28. The receiver according to claim 26, wherein the cooperative control data plurally includes the requirement data corresponding to a single peripheral device or a combination of peripheral devices, and the command to be executed when the requirement represented by each of the requirement data is satisfied.

29. The receiver according to claim 26, wherein the cooperative control data includes a command for playing back moving images relevant to the program, a command to be executed for time-shift recording of the program after the moving images are stated to playback, and a command to be executed for time-shift playback of the recorded program after the moving images are completely played back.

30. The receiver according to claim 29, wherein the cooperative control section prohibits playing back the moving images after a time, which is computed using time data received together with the moving images to see how long it takes for the moving images to be played back.

31. The receiver according to claim 26, wherein the cooperative control data includes the requirement data representing a requirement that a user agrees to view a CM if wanting to print a content relevant to the program, and a plurality of commands to be executed only when the requirement represented by the requirement data is satisfied, and
the plurality of commands include a command for making a document image processor print out the content relevant to the program, and a command for playing back the CM during when the content is printed out.

32. The receiver according to claim 31, wherein the cooperative control data further includes a command for controlling a channel or a power supply during when the CM is played back.

33. The receiver according to claim 26, wherein the cooperative control data includes a command for displaying a result derived based on data relevant to the program and data provided from the peripheral device.
